(19) United States
(12) Patent Application Publication
(10) Pub. No.: US 2019/0083987 A1
(43) Pub. Date: Mar. 21, 2019

(54) AUTOMATIC PAPER FEEDING METHOD FOR PAPER SHREDDER AND PAPER SHREDDER WITH IMPROVED AUTOMATIC PAPER FEEDING DEVICE

(71) Applicant: Bonsen Electronics Limited, Dong Guan City (CN)

(72) Inventors: Ning Xu, Dong Guan City GuangDong (CN); Qincan Li, Dong Guan City GuangDong (CN)

(73) Assignee: Bonsen Electronics Limited, Dong Guan City (CN)

(21) Appl. No.: 15/911,188

(22) Filed: Mar. 5, 2018

(30) Foreign Application Priority Data
Sep. 21, 2017 (CN) 201710858774.1
Sep. 21, 2017 (CN) 201710859261.2

(51) Int. Cl. B02C 18/22; B02C 18/00; B02C 18/08; B02C 23/04; B02C 18/24

(52) U.S. Cl. CPC B02C 18/2283; B02C 18/0007; B02C 2018/168; B02C 23/04; B02C 18/24; B02C 18/08

(57) ABSTRACT

The present invention discloses an automatic paper feeding method for a paper shredder and a paper shredder, including a step of disposing paper, a step of pressing paper, a step of automatically feeding paper continuously, and a step of shredding paper. The paper sheets to be shredded entering the automatic paper feeding channel are superimposed partially; the paper disposing mechanism and the automatic paper feeding channel of the paper shredder are located at two sides of the paper rolling device respectively; the paper rolling device is located at least at the position above the lower end portion of the paper disposing area/paper sheets to be shredded. In the present invention, the paper sheets to be shredded conveyed to the automatic paper feeding channel are superimposed partially; during shredding, the shredding cutter shreds a plurality of paper sheets to be shredded at a time, with a higher feed speed and an increased shred speed. Besides, the automatic feed speed can be adjusted. The present invention has an intelligent paper feeding function, which effectively prevents the overload during the automatic paper feeding and the automatic shredding.

### CROSS-REFERENCE TO RELATED APPLICATIONS

The present application claims priority from Chinese patent Application No. CN201710859261.2 filed on Sep. 21, 2017 and Chinese patent Application No, CN201710858774.1 filed on Sep. 21, 2017, the entire contents of which are incorporated herein by reference.

### TECHNICAL FIELD

The present invention relates to the field of paper shredder technologies, in particular to an automatic paper feeding method for a paper shredder and a paper shredder with an improved automatic paper feeding device.

### BACKGROUND

A paper shredder is equipped with an automatic paper feeding device which is configured to successively drive a piece of paper on the top of a stack of paper disposed at an automatic paper entry slot to smoothly enter an automatic paper feeding channel through a friction force generated by a rotation of a paper roller or a rubber roller, and to shred paper sheets by a shredding cutter in the automatic paper feeding channel.

The prior automatic paper feeding device for a paper shredder has the following problems. Firstly, the automatic paper feeding device rubs the paper sheet on the top in one-way direction to move downwards, so as to automatically enter the automatic paper feeding channel. The paper roller or the rubber roller is configured to start rubbing the paper sheet from its end portion; after the paper sheet on the, top moves downwards, and is entirely separated from the paper roller to enter the paper feeding channel, the paper roller starts to rub the next paper sheet. The automatic paper feeding device can only feed one piece of waste paper at a time to the shredding cutter, that is, the shredding cutter only shreds the paper one page at a time, with extra-low feed speed and shred efficiency. Secondly, the feed speed is only determined by a rotating speed of the paper roller and is not adjustable, so there needs an improvement.

### SUMMARY

In view of the defects of the prior art, the first object of the present invention is to provide an automatic paper feeding method for a paper shredder, which implements automatic paper feeding by using a brand-new feed method, stably and reliably feeds paper automatically, and improves the feed speed and the shred speed.

In order to achieve the above object, the present invention adopts the following technical solution. The automatic paper feeding method for a paper shredder includes the following steps:

1) a step of disposing paper, in which the stacked paper sheets to be shredded are disposed in a paper disposing area of a paper disposing mechanism to form a paper pile which is inserted from the outside of a paper rolling device, a lower end portion of the paper pile exceeds the paper rolling device by a distance of H, such that the paper sheets to be shredded and an automatic paper feeding channel are located at two sides of the paper rolling device respectively;

2) a step of pressing paper, in which a paper pressing mechanism presses the paper sheets to be shredded against the paper rolling device;

3) a step of automatically rolling paper, in which the paper rolling device is controlled to rotate in a forward direction and to automatically roll paper sheets continuously, the upper part of the paper rolling device rotates towards the side where the automatic paper feeding channel is located from the side where the paper sheets to be shredded are located, the paper rolling device starts to rub the paper sheet to be shredded from the position above the lower end portion of the paper sheet to be shredded, such that the lower end portion of the paper sheet to be shredded gets over the paper rolling device after reaching the position where the paper rolling device is located and enters the automatic paper feeding channel;

4) a step of automatically feeding paper continuously, in which the paper rolling device is controlled to rotate in a forward direction persistently, and to continuously rub the paper sheet to be shredded on the top of the paper pile, such that the paper sheets to be shredded getting over and/or entering the, automatic paper feeding channel are superimposed partially;

5) a step of shredding paper, in which the paper sheets to be shredded entering the automatic paper feeding channel or several superimposed paper sheets to be shredded are shredded by the shredding cutter in a paper shredder core.

In a further technical solution, the present invention improves the feed speed and the shred speed, intelligently feeds paper automatically, effectively prevents overload, and has stable and reliable actions by using a brand-new feed method and an overload processing mode. The paper shredder has an anti-overload paper feed limiting step, in which at least one paper feeding set value and/or working strength set value is stored or set in a control circuit, by a detection device detecting the number/thickness of the paper sheets of the automatic paper feeding channel and/or the working strength of the paper shredder, and conveying one corresponding detection value to the control circuit, in the case that the detection value received by the control circuit is greater than the paper feeding set value or the working strength set value, the paper rolling is stopped by the control circuit controlling the paper rolling device, and the paper shredder stops the automatic paper feeding, but simultaneously, the shredding cutter is controlled to keep shredding, until the detection value received by the control circuit is less than the paper feeding set value or the working strength set value, the paper rolling device is controlled by the control circuit again to resume the paper rolling, and the paper shredder resumes the automatic paper feeding; the number/thickness of the paper sheets to be shredded entering the automatic paper feeding channel is controlled within the set range, to avoid the overload of the paper shredder.

In view of the defects of the prior art, the second object of the present invention is to provide a paper shredder with an improved automatic paper feeding device, with a simple structure, stable and reliable actions and improved feed speed and shred speed.

In order to achieve the above-mentioned object, the present invention adopts the following technical solution. A paper shredder with an improved automatic paper feeding device includes a paper shredder head, on which an automatic paper feeding channel, a paper rolling device and a paper disposing mechanism are arranged, a shredding cutter is arranged in or below the automatic paper feeding channel, the paper disposing mechanism is provided with a paper disposing area for disposing paper sheets to be shredded, the paper disposing mechanism and the automatic paper feeding channel are located at two sides of the paper rolling device respectively; the automatic paper feeding channel and the paper disposing area are located at two sides of the paper rolling device respectively; the paper rolling device is located at the middle section of the paper disposing area/paper sheets to be shredded, or the paper rolling device is located at least at the position above the lower end portion of the paper disposing area/paper sheets to be shredded; the paper rolling device starts to rub the paper sheets to be shredded from the position above the lower end portion of the paper sheet to be shredded or its middle portion to leave from the paper disposing area first and to enter the automatic paper feeding channel in a forward direction again after the lower end portion of the paper sheet to be shredded gets over the paper rolling device.

In a further technical solution, the present invention is provided with an intelligent automatic paper feeding and anti-overload processing device, which improves the feed speed and the shred speed, effectively prevents the overload, and has stable and reliable actions. The paper shredder is provided with a detection device for detecting the number/thickness of the paper sheets entering the automatic paper feeding channel or a voltage/current of the paper shredder, and conveying a detection value to the control circuit an input terminal of the control circuit is electrically connected with the detection device, an output terminal of the control circuit is electrically connected with a shredding motor and a paper rolling motor respectively; the paper shredder has a normal shredding state, an anti-overload paper feed limiting shredding state and an overload protection state. In the normal shredding state, the control circuit controls the paper rolling motor to rotate and the shredding motor to rotate, the paper rolling device rotates and roll-feeds the paper sheets to be shredded into the automatic paper feeding channel, the shredding cutter rotates to shred paper sheets. In the anti-overload paper feed limiting shredding state, during the automatic paper feeding, in the case that the detection value received by the control circuit is greater than the paper feeding set value or the working strength set value, the control circuit controls the paper shredder to get into the anti-overload paper feed limiting shredding state, the control circuit controls the paper rolling motor to stop, the shredding motor keeps rotating, the paper rolling device stops paper rolling, and the shredding cutter keeps shredding.

In the anti-overload paper feed limiting shredding state, in the case that the detection value received by the control circuit is less than the paper feeding set value or the working strength set value, the control circuit controls the paper shredder to get into the normal shredding state, the control circuit controls the paper rolling motor to start rotating, the shredding motor keeps rotating, the paper rolling device starts rolling, and the shredding cutter keeps shredding. In the overload protection state, in the case that the detection value received by the control circuit is greater than an overload critical value m, the control circuit controls the paper shredder to get into the overload protection state.

In view of the defects of the prior art, the third object of the present invention is to provide a paper shredder with an improved automatic paper feeding device, which is able to adjust the automatic feed speed.

In order to achieve the above-mentioned object, the present invention adopts the following technical solution. The paper disposing area and/or the paper inserting chamber is provided with a paper inserting depth adjusting mechanism including a driving mechanism and a paper supporting mechanism. The driving mechanism is connected with the paper supporting mechanism, the paper supporting mechanism includes the bottom of the paper inserting chamber or a lifting support board arranged in the paper disposing area/paper inserting chamber; in the case that the feed speed is adjusted, the driving mechanism drives the paper inserting chamber or the listing support board to rise or descend.

Compared with the prior art, the present invention has the following advantages.

First of all, the present invention automatically conveys the paper sheets to be shredded to the automatic paper feeding channel continuously, and the paper sheets to be shredded conveyed to the automatic paper feeding channel are superimposed partially. During shredding, the shredding cutter shreds a plurality of paper sheets to be shredded at a time, with a higher feed speed and an increased shred speed.

Secondly, the present invention has an intelligent paper feeding function. Before the number or thickness of the paper sheets entering the automatic paper feeding channel reaches the maximum, the automatic paper feeding is stopped automatically, while the paper shredder keeps shredding, which effectively prevents the overload during the automatic paper feeding and the automatic shredding.

Thirdly, the present invention adjusts the, feed speed by adjusting the height of the paper inserting chamber or the lifting support board, and adjusts an initial rubbing position of the paper roller on the paper sheets to be shredded, thereby adjusting the superimposed length of two adjacent paper sheets to be shredded entering the automatic paper feeding channel, adjusting the superimposed number of the paper sheets to be shredded conveyed to the automatic paper feeding channel, and adjusting the automatic feed speed.

### BRIEF DESCRIPTION OF THE DRAWINGS

The present invention will be further explained below in combination with drawings and embodiments.

FIG. 1 is a structural schematic diagram of the present invention,

FIG. 2 is a structural schematic diagram with a hidden housing of a paper shredder head according to the present invention.

FIG. 3 is a structural schematic diagram of a paper disposing area where paper sheets to be shredded are disposed according to the present invention,

FIG. 4 is a structural schematic diagram when a paper rolling device starts to rub paper according to the present invention.

FIG. 5 is a structural schematic diagram when the previous paper sheet to be shredded gets over a paper roller and the paper roller starts to rub the next paper sheet according to the present invention,

FIG. 6 is a structural schematic diagram when the paper sheet to be shredded gets over the paper roller and enters the automatic paper feeding channel according to the present invention.

FIG. 7 is a structural schematic diagram when the shredding cutter starts to shred according to the present invention.

FIG. 8 is a structural schematic diagram of continuous automatic paper feeding and shredding according to the present invention,

FIG. 9 is a structural schematic diagram of a paper pressing mechanism according to the present invention.

FIG. 10 is a structural schematic diagram of a lifting support board according to the present invention.

### REFERENCE NUMERALS

1. paper sheet to be shredded, 2, paper roller, 3. lifting support board, 4. paper inserting chamber, 5. automatic paper feeding channel, 6. shredding cutter, 8. groove, 9. paper shredder core, 10. rotating shaft, 11. top paperboard, 12. driven shaft, 13. friction transmission roller, 14. window, 15. automatic paper entry slot, 16, paper supporting board, 71, safety coverplate.

### DETAILED DESCRIPTION

The following merely describes preferable embodiments of the present invention, and does not intend to limit the protection scope of the present invention.

### First Embodiment

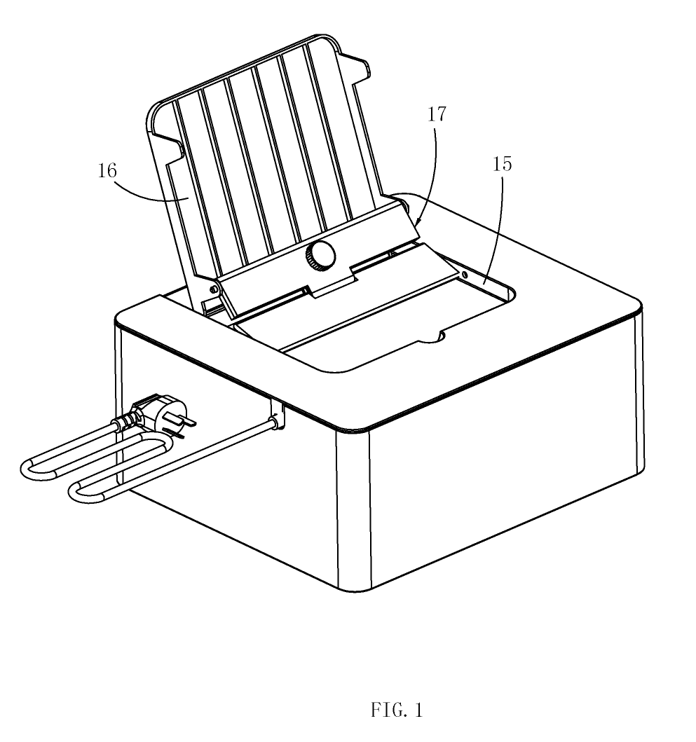

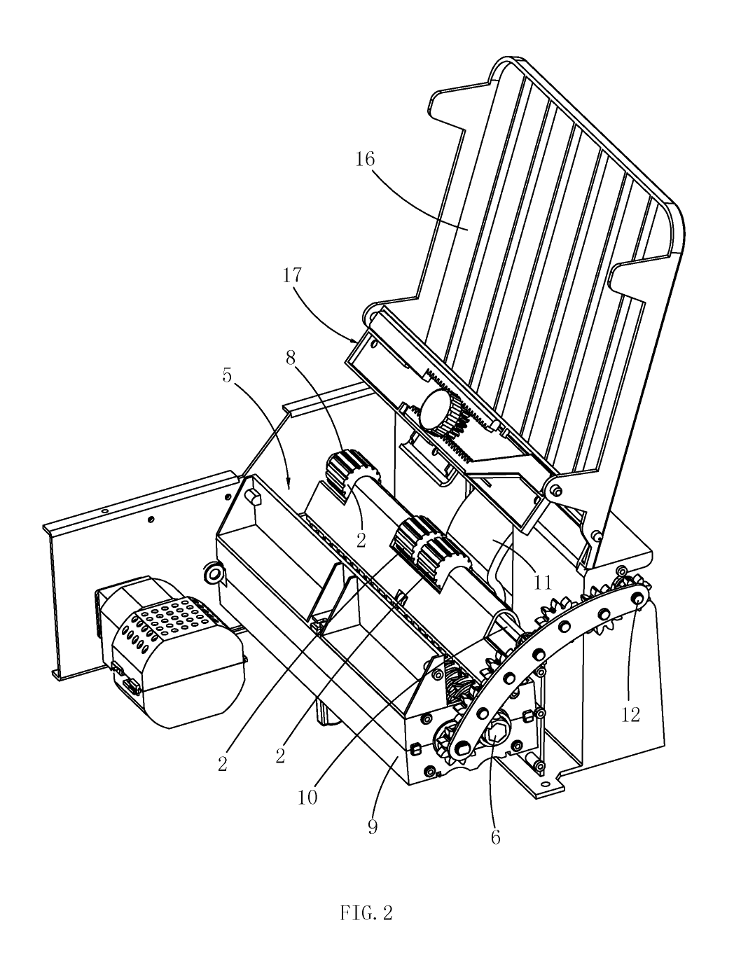

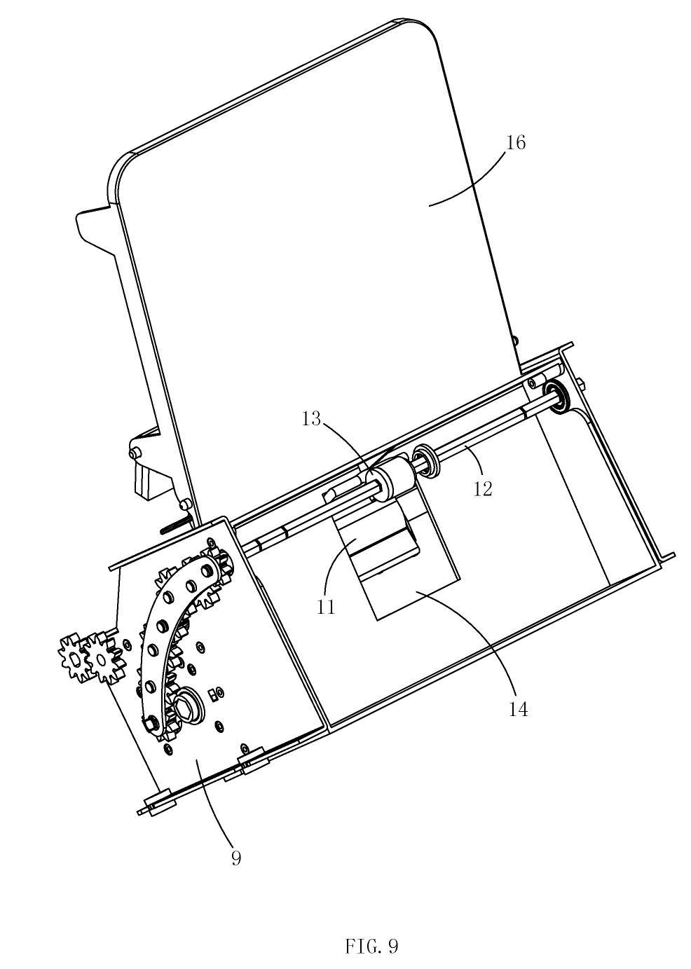

As shown in FIGS. 1 to 10, the automatic paper feeding method for a paper shredder includes the following steps:

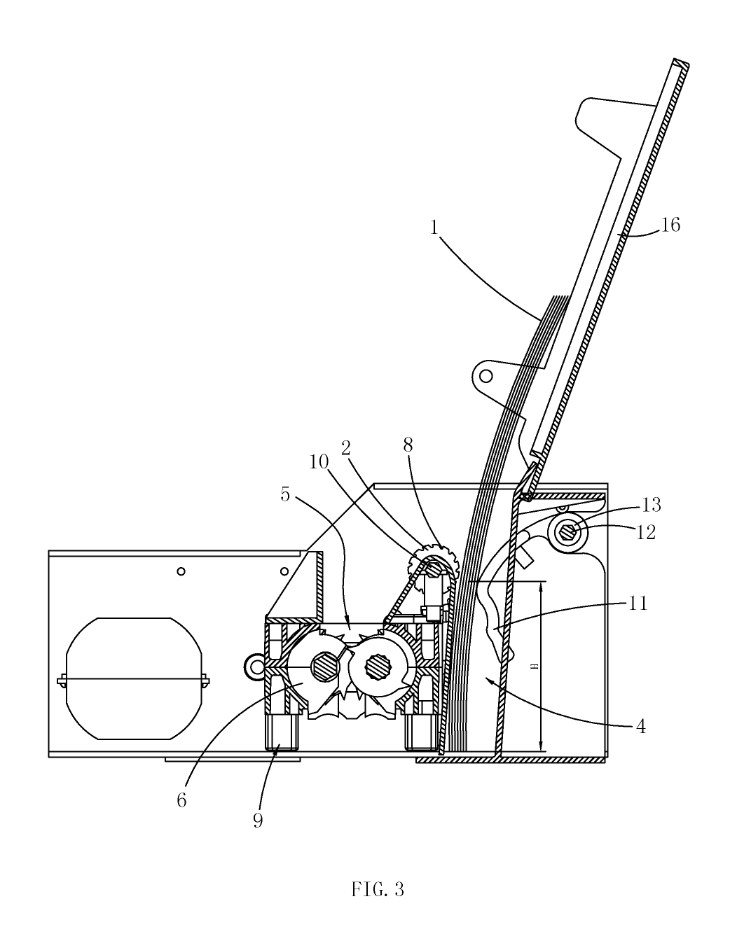

1) a step of disposing paper, in which the stacked paper sheets to be shredded 1 are disposed in a paper disposing area of a paper disposing mechanism to form a paper pile which is inserted from the outside of a paper rolling device, a lower end portion of the paper pile exceeds the paper rolling device by a distance of H, as shown in FIG. 3, such that the paper sheets to be shredded 1 and an automatic paper feeding channel 5 are located at two sides of the paper rolling device respectively. A paper roller set or a paper roller 2 may be used as the paper rolling device, the lower end portion of the paper pile is inserted to the paper inserting chamber 4 located at the outside of the paper roller 2 or the lifting support board 3, and the bottom of the paper inserting chamber 4 or the lifting support board 3 is lower than the set height of the paper roller 2, by adjusting the position of the bottom of the paper inserting chamber 4 or the lifting support board 3 for supporting the paper pile with respect to the paper roller 2, the adjustment of the automatic feed speed is realized, including the adjustment of the superimposed length of the two adjacent paper sheets to be shredded 1 entering the automatic paper feeding channel 5, and the adjustment of the number of superimposed paper sheets to be shredded 1 entering the automatic paper channel 5. The height of the bottom of the paper inserting chamber 4 or the lifting support board 3 is driven and adjusted directly by a mechanism driving assembly such as a knob and a push switch, the bottom of the paper inserting chamber 4 or the lifting support board 3 may be driven to rise and descend by a motor which is controlled by means of electronic control, as long as the initial rubbing position of the paper roller 2 on the paper sheets to be shredded 1 is adjustable, and the automatic feed speed is adjustable.

2) a step of pressing paper, in which a paper pressing mechanism presses the paper sheets to be shredded 1 against the paper rolling device, such that there is a relatively large friction force between the paper roller 2 of the paper rolling device and the paper sheets to be shredded 1, and the paper rolling device may smoothly rub the paper sheets to be shredded 1.

3) a step of automatically rolling paper, in which the paper rolling device is controlled to rotate in a forward direction and to automatically roll paper sheets continuously, the upper part of the paper rolling device rotates towards the side where the automatic paper feeding channel 5 is located from the side where the paper sheets to be shredded 1 are located, the paper rolling device starts to rub the paper sheet to be shredded 1 from the position above the lower end portion of the paper sheet to be shredded 1, such that the lower end portion of the paper sheet to be shredded 1 gets over the paper rolling device after reaching the position where the paper rolling device is located and enters the automatic paper feeding channel 5; as shown in FIGS. 3-8, the paper rolling device starts rubbing the paper sheets to be shredded 1 from the middle of the paper sheets to be shredded 1, such that the paper sheets to be shredded 1 entering the automatic paper feed channel 5 are arranged in an echeloned manner, and the two adjacent paper sheets to be shredded 1 are superimposed partially, the lower end portion of the paper pile exceeds the paper rolling device by a distance of H; by adjusting the distance H of the lower end portion of the paper pile exceeding the paper rolling device, the, automatic feed speed and the superimposed length L of the two adjacent paper sheets to be shredded 1 entering the automatic paper feeding channel 5 are adjusted.

The automatic paper rolling step including the following sub-processes:

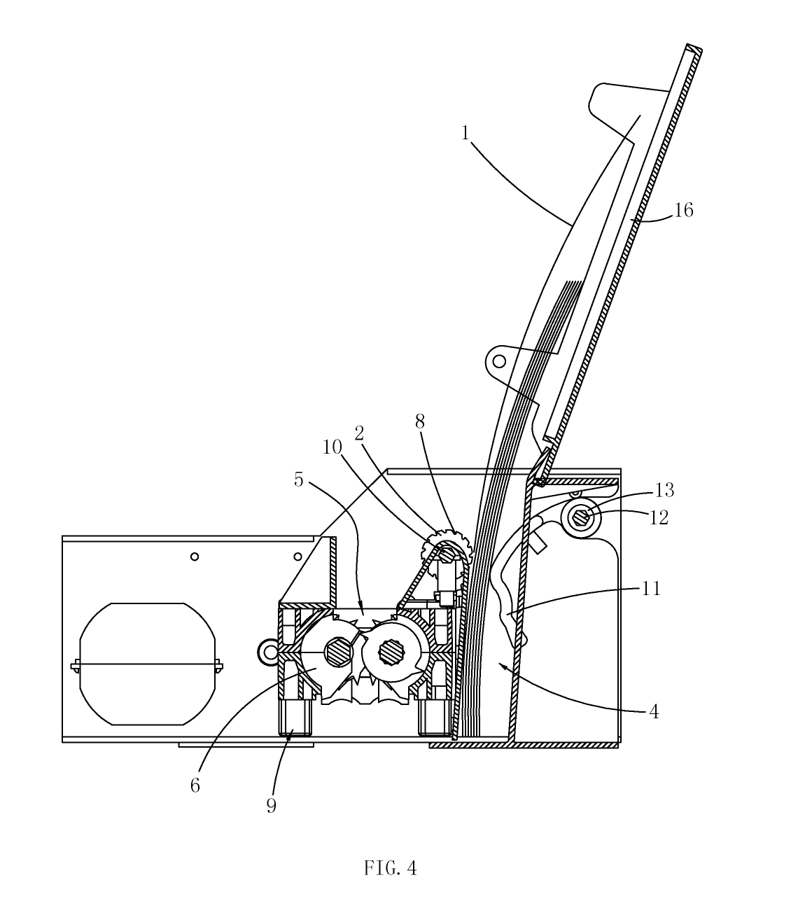

a) a sub-process of rubbing paper sheets in a backward direction, in which the paper roller set or the paper roller 2 may be used as the paper rolling device, the paper roller 2 is controlled to rotate in a forward direction continuously; in the case that the paper roller 2 rotates in a forward direction, only the paper sheet to be shredded 1 on the top of the paper pile is rubbed to move upwards or outwards, and the paper roller 2 starts rubbing the paper sheet to be shredded 1 from its middle, the lower end portion of the paper sheet to be shredded 1 contacting with the paper roller 2 is moved upwards or outwards to the position where the paper roller 2 is located, as shown in FIG. 4:

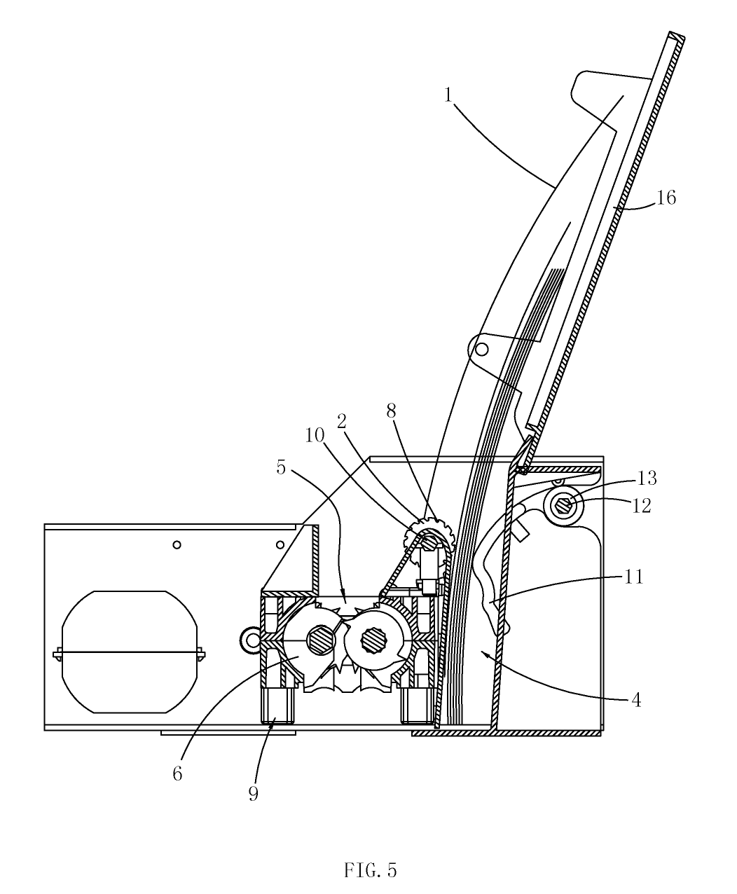

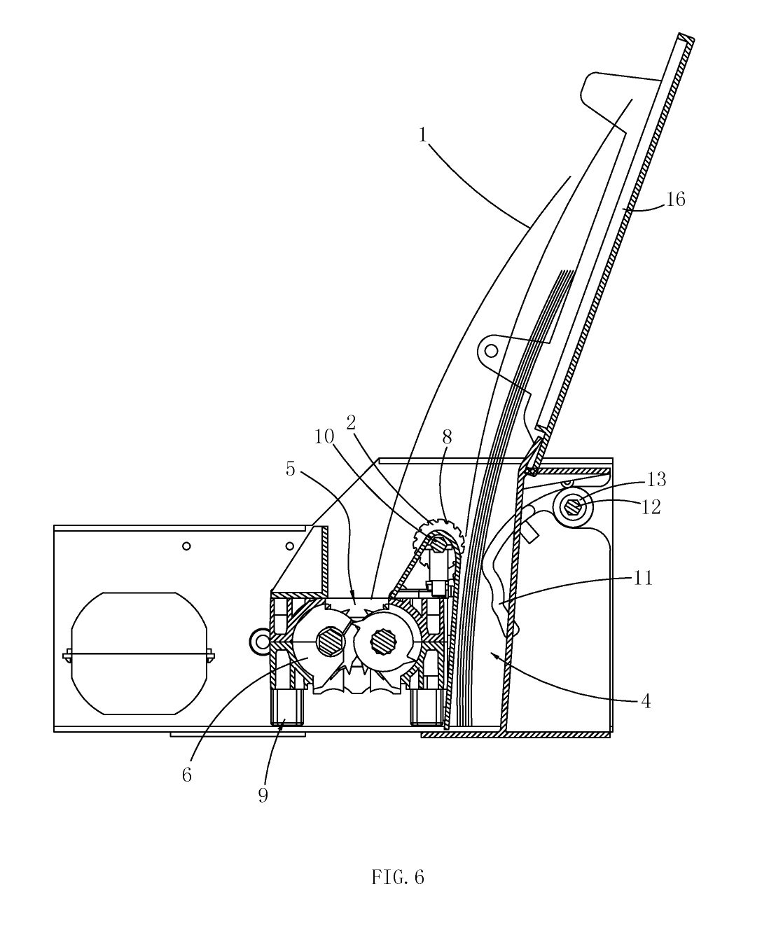

b) a sub-process of getting over paper roller 2, in which after the rubbed lower end portion of the paper sheet to be shredded 1 is moved to the position where the paper roller 2 is located, as the paper roller 2 continues to rotate in a forward direction, the paper roller 2 roll-feeds or pushes the lower end portion of the paper sheet to be shredded 1, the lower end portion of the paper sheet to be shredded 1 is moved to the side where the automatic paper feeding channel 5 is located from the outside of the paper roller 2, as shown in FIG. 5, the lower end portion of the paper sheet to be shredded 1 gets over the upper part of the paper roller 2 and enters the automatic paper feeding channel 5, as shown in FIG. 6;

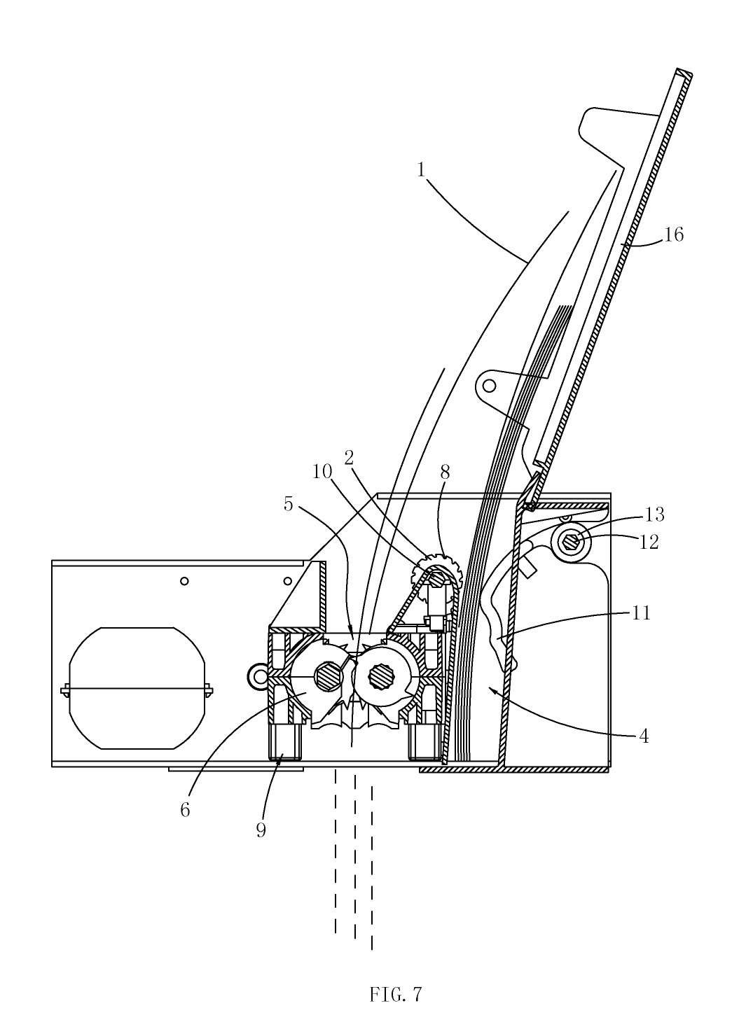

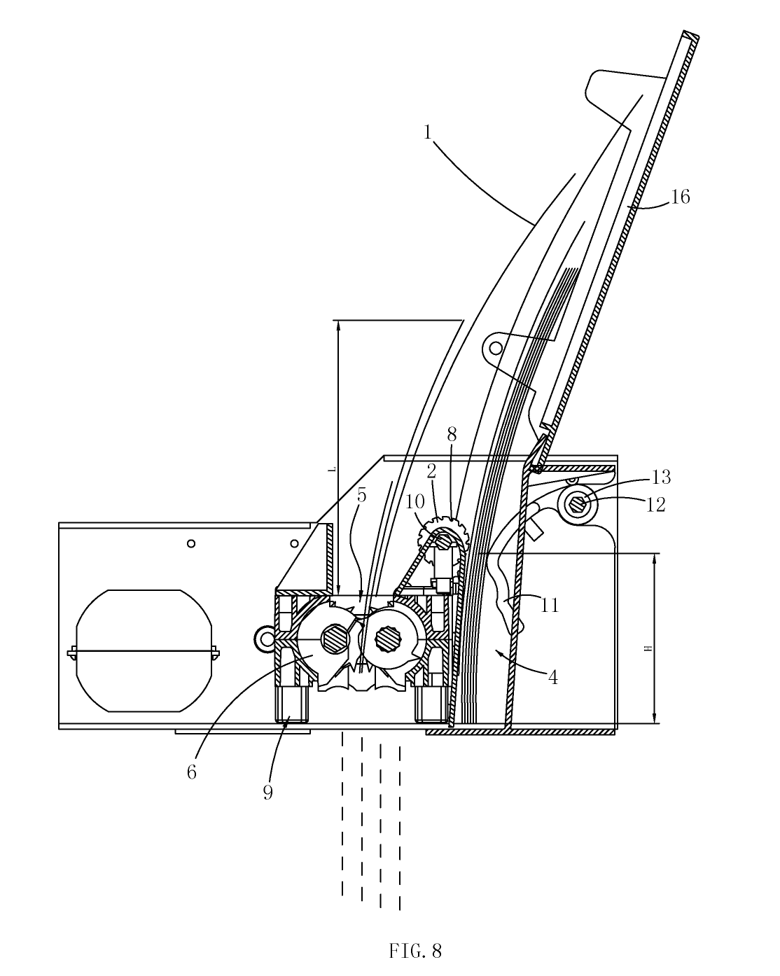

c) a sub-process of absorbing, rolling and shredding, in which the paper sheet to be shredded 1 entering the automatic paper feeding channel 5 is absorbed and rolled into the paper shredder core 9 by a paper absorbing and rolling mechanism or the shredding cutter 6 installed in the automatic paper feeding channel 5, and is shredded by the shredding cutter 6, as shown in FIGS. 7 and 8;

The paper sheets to be shredded 1 are rubbed to move by a friction surface, grooves 8, concave stripes, convex stripes or convex teeth arranged on a surface of the paper roller 2. Preferably, several grooves 8 or convex bars are arranged at intervals on the surface of the paper roller 2 in a circumferential direction. In the case that the lower end portion of the paper sheet to be shredded 1 reaches the upper part of the paper roller 2, the lower end portion of the paper sheet to be shredded 1 may be inserted or fall in, the grooves 8 or a gap between two adjacent convex bars. By rolling and poking the lower end portion of the paper sheet to be shredded 1 through the grooves 8 or the convex bars, the lower end portion of the paper sheet to be shredded 1 gets over the paper roller 2 smoothly, to reach the side where the automatic paper feeding channel 5 is located

4) a step of automatically feeding paper continuously, in which the paper rolling device is controlled to keep rotating in a forward direction, the paper rolling device continuously rubs the paper sheet to be shredded 1 on the top of the paper pile, such that the paper sheets to be shredded 1 getting over the automatic paper feeding channel 5 or entering the automatic paper feeding channel 5 are superimposed partially; during the automatic continuous paper feeding, the superimposed lengths of the two adjacent paper sheets to be shredded 1 entering the automatic paper feeding channel 5 are the same substantially.

5) a step of shredding paper, in which the paper sheets to be shredded 1 entering in the automatic paper feeding channel 5 or several superimposed paper sheets to be shredded 1 are shredded by the shredding cutter 6 in a paper shredder core 9.

In the present invention, the prior way of automatic paper feeding has been changed since the paper roller 2 does not rub the paper sheets to be shredded 1 directly to enter the automatic paper feeding channel 5, but firstly rub the paper sheets to be shredded 1 to move upwards or outwards, that is, the paper sheets to be shredded 1 firstly moves in a direction opposite to the paper feeding direction of the automatic paper feeding channel 5, such that the paper sheets to be shredded 1 leave from the paper inserting chamber 4 firstly, and then enter the automatic paper feeding channel 5 after the lower end portion of the paper sheet to be shredded 1 gets over the paper roller 2. During this process, the paper roller 2 keeps rotating in the same direction, without changing the direction or stopping, or other assistant devices to change the moving direction of the paper sheets to be shredded 1, thereby forming the partially superimposed paper sheets in the automatic paper feeding channel 5 continuously, and conveying the paper sheets to be shredded 1 continuously. During shredding, the shredding cutter 6 shreds a plurality of paper sheets to be shredded 1 at a time, with a higher feed speed and an increased shred speed.

Additionally, the present invention adjusts the feed speed by adjusting the height of the paper inserting chamber 4 or the lifting support board 3, and adjusts an initial rubbing position of the paper roller 2 on the paper sheets to be shredded 1, thereby adjusting the superimposed length of two adjacent paper sheets to be shredded 1 entering the automatic paper feeding channel 5, adjusting the superimposed number of the paper sheets to be shredded 1 conveyed to the automatic paper feeding channel 5, and adjusting the automatic feed speed.

### Second Embodiment

As shown in FIGS. 1-10, the present embodiment additionally includes an anti-overload paper feed limiting step, compared with the first embodiment, so as to implement the intelligent automatic paper feeding, including the following steps: 1) a step of disposing paper, 2) a step of pressing paper, 3) a step of automatically rolling paper, 4) a step of automatically feeding paper continuously, 5) a step of shredding paper, and 6) an anti-overload paper feed limiting step, wherein the step of disposing paper, the step of pressing paper, the step of automatically rolling paper, the step of automatically feeding paper continuously, and the step of shredding paper are the same as the corresponding steps in the first embodiment, and are not repeated herein.

In the anti-overload paper feed limiting step, at least one paper feeding set value or working strength set value is stored or set in the control circuit. By the detection device detecting the number or thickness of the paper sheets of the automatic paper feeding channel 5, the working strength of the paper shredder is detectable. For example, a voltage or current of the shredding motor is detected, and one corresponding detection value is conveyed to the control circuit.

In the case that the detection value received by the control circuit is greater than the paper feeding set value or the working strength set value, by the control circuit controlling the paper rolling device to stop rolling paper, the paper shredder stops the automatic paper feeding, and controls the shredding cutter 6 to keep shredding, until the detection value received by the control circuit is less than the paper feeding set value or the working strength set value, by the control circuit controlling the paper rolling device to resume rolling again, the paper shredder resumes automatic paper feeding.

The number/thickness of the paper sheets to be shredded I entering the automatic paper feeding channel 5 is controlled within the set range, to avoid the overload of the paper shredder.

The anti-overload paper feed limiting step includes a detecting step which may select one or a combination of the following modes.

a) By a paper number/thickness detecting device detecting the number or thickness of the paper sheets to be shredded I entering the automatic paper feeding channel 5, and conveying one corresponding detection value to the control circuit, the control circuit compares the detection value with the paper feeding set value;

b) by a voltage/current detecting device detecting the working voltage or current of the shredding motor of the paper shredder, and conveying one corresponding detection value to the control circuit, the control circuit compares the detection value with the working strength set value;

In the case that the overload occurs in the paper shredder or the number of paper sheets of the automatic paper feeding channel 5 reaches the rated maximum, the paper shredder in this state is set to have an overload critical value m,

it is set that an increment of the detection value received by the control circuit is a single-sheet value n for each additional paper sheet to be shredded 1 in the automatic paper feeding channel 5, and the paper feeding set value or the working strength set value is set to be a;

in the case that the detection value received by the control circuit is greater than the paper feeding set value or the working strength set value, the detection value is still less than the overload critical value m, and the corresponding working state of the paper shredder at this point is as below: the paper shredder is not in the overload state, or does not reach the rated maximal working limit, or achieve the condition of triggering the overload protection;

overload critical value m−a>(0˜3)×single-sheet value n;

in the case that the detection value received by the control circuit is greater than the overload critical value m, the paper shredder is in the overload state, the control circuit triggers an overload protection instruction, and the paper shredder executes the overload protection instruction. For example, the shredding cutter 6 is controlled to make the set number of turns in a backward direction, then in a forward direction, and so forth at least once, for solving the problem of overload or paper jam.

In the present invention, the prior automatic paper feeding has been changed. The paper roller automatically feeds one paper sheet to be shredded 1 to the automatic paper feeding channel 5 at a time. After the previous paper sheet to be shredded 1 is separated from the rubbing position, the paper roller immediately rubs the next paper sheet to be shredded 1 to move upwards, and automatically conveys the next paper sheet to be shredded 1 to the automatic paper feeding channel 5 at least before the previous paper sheet to be shredded 1 completely enters the automatic paper sheet channel 5, and the two adjacent paper sheets to be shredded 1 are superimposed partially. During shredding, the shredding cutter shreds a plurality of paper sheets to be shredded at a time, with a higher feed speed and an increased shred speed.

The present invention has the point of an intelligent paper feeding function. Before the number or thickness of the paper sheets entering the automatic paper feeding channel reaches the maximum, the automatic paper feeding is stopped automatically, while the paper shredder keeps shredding, which effectively prevents the overload during the automatic paper feeding and the automatic shredding.

Additionally, in the automatic paper feeding, the paper roller 2 does not rub the paper sheets to be shredded 1 directly to enter the automatic paper feeding channel 5, but firstly rub the paper sheets to be shredded 1 to move upwards or outwards, that is, the paper sheets to be shredded 1 firstly moves in a direction opposite to the paper feeding direction of the automatic paper feeding channel 5, such that the paper sheets to be shredded 1 leave from the paper inserting chamber 4 firstly, and then enter the automatic paper feeding channel 5 after the lower end portion of the paper sheet to be shredded 1 gets over the paper roller 2. During this process, the paper roller 2 keeps rotating in the same direction, without changing the direction or stopping, or other assistant devices to change the moving direction of the paper sheets to be shredded 1, thereby forming the partially superimposed paper sheets in the automatic paper feeding channel 5 continuously, and conveying the paper sheets to be shredded 1 continuously. During shredding, the shredding cutter 6 shreds a plurality of paper sheets to be shredded 1 at a time, with a higher feed speed and an increased shred speed.

Furthermore, the present invention adjusts the feed speed by adjusting the height of the paper inserting chamber 4 or the lifting support board 3, and adjusts an initial rubbing position of the paper roller 2 on the paper sheets to be shredded 1, thereby adjusting the superimposed length of two adjacent paper sheets to be shredded entering the automatic paper feeding channel 5, adjusting the superimposed number of the paper sheets to be shredded conveyed to the automatic paper feeding channel 5, and adjusting the automatic feed speed.

### Third Embodiment

As shown in FIGS. 1-10, a paper shredder with an improved automatic paper feeding device includes a paper shredder head, on which an automatic paper feeding channel 5, a paper rolling device and a paper disposing mechanism are arranged, a shredding cutter 6 is arranged in or below the automatic paper feeding channel 5, the paper disposing mechanism is provided with a paper disposing area for disposing paper sheets to be shredded 1, the paper disposing mechanism and the automatic paper feeding channel 5 are located at two sides of the paper rolling device respectively; the automatic paper feeding channel 5 and the paper disposing area are located at two sides of the paper rolling device respectively; the paper rolling device is located at the middle section of the paper disposing area/paper sheets to be shredded 1.

The paper rolling device is located at least at the position above the lower end portion of the paper disposing area/paper sheets to be shredded 1; as long as the two adjacent paper sheets to be shredded 1 are superimposed partially at the higher side of the paper disposing area when the paper rolling device rubs the two adjacent paper sheets to be shredded 1, or the two adjacent paper sheets to be shredded 1 are superimposed partially after entering one side of the automatic paper feeding channel 5.

The paper rolling device starts to rub the paper sheets to be shredded from the position above the lower end portion of the paper sheets to be shredded or its middle portion to leave from the paper disposing area first, and to enter the automatic paper feeding channel in a forward direction again after the lower end portion of the paper sheet to be shredded gets over the paper roiling device.

In the present invention, the prior automatic paper feeding has been changed. The paper roller automatically feeds one paper sheet to be shredded 1 to the automatic paper feeding channel 5 at a time. After the previous paper sheet to be shredded 1 is separated from the rubbing position, the paper roller immediately rubs the next paper sheet to be shredded 1 to move upwards, and automatically conveys the next paper sheet to be shredded 1 to the automatic paper feeding channel 5 at least before the previous paper sheet to be shredded 1 completely enters the automatic paper sheet channel 5, and the two adjacent paper sheets to be shredded 1 are superimposed partially. During shredding, the shredding cutter shreds a plurality of paper sheets to be shredded at a time, with a higher feed speed and an increased shred speed.

The paper shredder head is provided with a paper shredder core 9 and a transmission mechanism. The paper rolling device includes a spindle 10 and several paper rollers 2, wherein the spindle 10 is rotationally mounted at the paper shredder core 9, the transmission mechanism is connected with the spindle 10 in a transmission way, the spindle body is installed with at least one paper roller 2; one to three paper rollers 2 is/are mounted at the middle and/or two sides of the spindle body respectively, and the surface of the paper roller 2 is provided with a rubbing friction surface, grooves 8, concave stripes, convex stripes or convex teeth. Preferably, several grooves 8, convex teeth or convex bars are arranged at intervals on the surface of the paper roller 2 in a circumferential direction. In the case that the lower end portion of the paper sheet to be shredded 1 reaches the upper part of the paper roller 2, the lower end portion of the paper sheet to be shredded 1 may be inserted or fall in the grooves 8 or a gap between two adjacent convex bars. By rolling and poking the lower end portion of the paper sheet to be shredded 1 through the grooves 8 or the convex bars, the lower end portion of the paper sheet to be shredded 1 gets over the paper roller 2 smoothly, to reach the side where the automatic paper feeding channel 5 is located.

The paper disposing mechanism includes at least one paper inserting chamber 4, the automatic paper feeding channel 5 and the paper inserting chamber 4 are located at two sides of the paper roller 2 respectively, and the paper inserting chamber 4 extends from a lower direction of the paper roller 2 at least to the position where the paper roller is located. The paper roller 2 starts to rub the paper sheets to be shredded 1 from the middle of the paper sheets to be shredded 1 to leave from the paper inserting chamber 4 first, and to enter the automatic paper feeding channel 5 in a forward direction again after the lower end portion of the paper sheet to be shredded 1 gets over the paper roller 2.

The paper shredder head is provided with a paper pressing mechanism which includes a paper pressing driving mechanism and a top paperboard 11, wherein the paper pressing driving mechanism is connected with the top paperboard 11 which extends into the paper inserting chamber 4 from its outside. The part of the top paperboard 11 extending into the paper inserting chamber 4 forms one paper pressing portion which is located at one side of the paper rolling device, and moves towards the paper rolling device.

The paper shredder core 9 is rotationally provided with a driven shaft 12 which is arranged outside the paper inserting chamber 4, and is connected with the transmission mechanism in a transmission way; the shaft body of the driven shaft 12 is fixed with at least one friction transmission roller 13, a friction transmission hole is provided on the upper part of the top paperboard 11, and the friction transmission roller 13 is movably penetrated through the friction transmission hole. In the rotation of the driven shaft 12, the friction transmission roller 13 and the friction transmission hole are in transmission fit by the friction force between the roller surfaces; at least one window 14 is provided at the middle of an outer side wall of the paper inserting chamber 4. The lower middle part of the top paperboard 11 passes through the window 14 and extends into the paper inserting chamber 4, for abutting the middle part of the paper sheet to be shredded 1 inserted to the paper inserting chamber 4 against the paper roller 2, such that there is a relatively large friction force between the paper roller 2 of the paper rolling device and the paper sheet to be shredded 1, and the paper rolling device smoothly rubs the paper sheets to be shredded 1.

An automatic paper entry slot 15 is arranged on the upper part of the paper shredder head, the paper insetting chamber 4 is arranged at the outside of the automatic paper entry slot 15, the paper roller 2 is located in the middle of the automatic paper entry slot 15, the automatic paper feeding channel 5 is arranged at an inside position of the automatic paper entry slot 15; the paper disposing mechanism includes a paper supporting board 16 and a security coverplate 17 which may be a single coverplate or a foldable composition board formed by connecting a plurality of plate bodies. The lower end portion of the paper supporting board 16 is rotationally mounted at the upper part of the paper shredder head, and is connected with or close to the upper portion of the back side wall of the paper inserting chamber 4. When the automatic paper feeding function is not used, the paper supporting board 16 is covered on the upper part of the automatic paper entry slot 15; the inner side of the security coverplate 17 is pin jointed or clamped at the inner side of the automatic paper entry slot 15, the outer side of the security coverplate 17 is clamped at the middle of the paper supporting board 16. During shredding, the security coverplate 17 covers on the automatic paper entry slot 15, for eliminating the potential safety hazard.

The paper disposing area or the paper inserting chamber 4 is provided with a paper inserting depth adjusting mechanism which includes a driving mechanism and a paper supporting mechanism, wherein the driving mechanism is connected with the paper supporting mechanism, the paper supporting mechanism includes the bottom portion of the paper inserting chamber 4, one receiving box is mounted at one side of the paper roller 2, the paper inserting chamber 4 is formed inside the receiving box, the driving mechanism drives the receiving box to rise or descend, such that the paper inserting chamber 4 rises or descends.

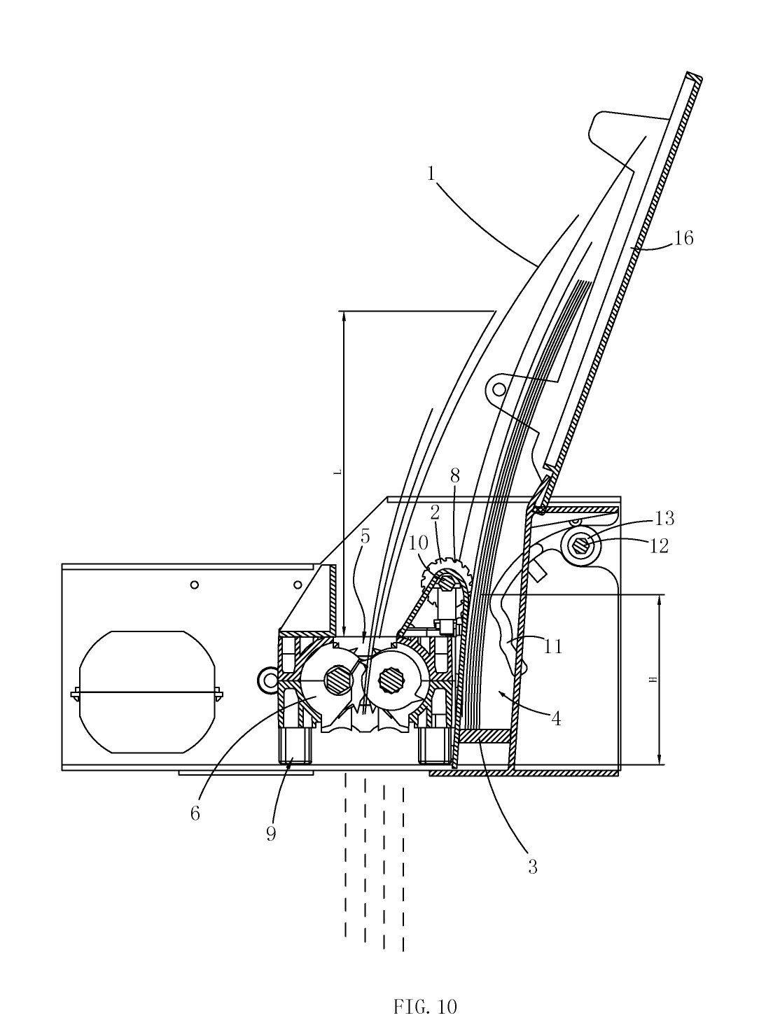

In the preferable embodiment, the paper supporting mechanism includes a lifting support board 3 arranged in the paper disposing area or the paper inserting chamber 4. As shown in FIG. 10, when the feed speed is adjusted, the driving mechanism drives the paper inserting chamber 4 or the lifting support board 3 to rise or descend, so as to adjust the automatic feed speed.

In the preferable embodiment, one knob or a push switch is arranged on the paper shredder head. The knob or the push switch is connected with the paper inserting chamber 4 or the lifting support board 3 by a transmission mechanism such as a connecting rod. When the knob is rotated or the push switch is pushed, the paper inserting chamber 4 or the lifting support board 3 is driven to rise or descend, so as to adjust the automatic feed speed.

In another preferable embodiment, one motor is mounted in the paper shredder core 9. The motor is connected with the paper inserting chamber 4 or the lifting support board 3 by a transmission mechanism such as a transmission gear or a rack. By the control switch controlling the motor to operate, the motor drives the paper inserting chamber 4 or the lifting support board 3 to rise or descend by the transmission mechanism.

In an initial state, the paper sheets to be shredded 1 disposed in the paper disposing area or the paper inserting chamber 4 are substantially upright or slightly inclines outwards. The contact position of the paper sheets to be shredded 1 with the paper roller 2 is the initial rubbing position. The distance of the initial rubbing position from the lower and portion of the paper sheets to be shredded is H, i.e., the distance of the contact position of the paper sheets to be shredded 1 with the paper roller 2 from the bottom of the paper inserting chamber 4 or the lifting support board 3 is H. By adjusting the distance H, the automatic feed speed is adjusted and the superimposed length L of the two adjacent paper sheets entering the automatic paper feeding channel 5 is adjusted, so as to adjust the automatic feed speed.

### Four Embodiment

The present embodiment additionally includes an anti-overload control device, compared with the third embodiment, so as to implement the intelligent automatic paper feeding. The main structure of the present embodiment is the same as that of the third embodiment, and is not repeated herein. As shown in FIGS. 1-10, a paper shredder with an improved automatic paper feeding device includes a paper shredder head, a shredding motor, a shredding cutter 6 and a control circuit, wherein the automatic paper entry slot is arranged on the paper shredder head; the automatic paper feeding channel 5, the paper rolling device and the paper disposing mechanism are arranged at the automatic paper entry slot, the shredding cutter 6 is arranged in or below the automatic paper feeding channel 5, the shredding motor is connected with the shredding cutter 6 in a transmission way, the paper disposing mechanism is provided with the paper disposing area for disposing the paper sheets to be shredded 1, and a paper rolling motor is arranged in the paper shredder head, and is connected with the paper rolling device.

The paper shredder is provided with a detection device for detecting the number/thickness of the paper sheets entering the automatic paper feeding channel 5 or a voltage/current of the paper shredder, and conveying a detection value to the control circuit; an input terminal of the control circuit is electrically connected with the detection device, an output terminal of the control circuit is electrically connected with a shredding motor and a paper rolling, motor respectively.

The paper shredder has a normal shredding state, an anti-overload paper feed limiting shredding state and an overload protection state.

In the normal shredding state, the control circuit controls the paper rolling motor to rotate and the shredding motor to rotate, the paper rolling device rotates and roll-feeds the paper sheets to be shredded 1 into the automatic paper feeding channel 5, the shredding cutter 6 rotates to shred paper sheets.

In the anti-overload paper feed limiting shredding state, during the automatic paper feeding, in the case that the detection value received by the control circuit is greater than the paper feeding set value or the working strength set value, the control circuit controls the paper shredder to get into the anti-overload paper feed limiting shredding state, the control circuit controls the paper rolling motor to stop, the shredding motor keeps rotating, the paper rolling device stops paper rolling, and the shredding cutter 6 keeps shredding.

In the anti-overload paper feed limiting shredding state, in the case that the detection value, received by the control circuit is less than the paper feeding set value or the working strength set value, the control circuit controls the paper shredder to get into the normal shredding state, the control circuit controls the paper rolling motor to start rotating, the shredding motor keeps rotating, the paper rolling device starts rolling, and the shredding cutter 6 keeps shredding,

In the overload protection state, in the case that the detection value received by the control circuit is greater than an overload critical value m, the control circuit controls the paper shredder to get into the overload protection state.

The control circuit is provided with a control unit which stores or sets the paper feeding set value or the working strength set value; the paper shredder is provided with a paper number/thickness detecting device for detecting the number or thickness of the paper sheets entering the automatic paper feeding channel 5, and conveying one corresponding detection value to the control circuit, or the paper shredder is provided with a voltage/current detecting device for detecting the voltage or current of the shredding motor, and conveying one corresponding detection value to the control circuit.

In the case that the overload occurs in the paper shredder or the number of paper sheets of the automatic paper feeding channel 5 reaches the rated maximum, the paper shredder in this state is set to have an overload critical value m.

It is set that an increment of the detection value received by the control circuit is a single-sheet value n for each additional paper sheet to be shredded 1 in the automatic paper feeding channel 5, and the paper feeding set value or the working strength set value is set to be a.

In the case that the detection value received by the control circuit is greater than the paper feeding set value or the working strength set value, the detection value is still less than the overload critical value m, and the corresponding working state of the paper shredder at this point is as below: the paper shredder is not in the overload state, or does not reach the rated maximal working limit, or achieve the condition of triggering the overload protection;

overload critical value m−a>(0˜3)×single-sheet value n;

in the case that the detection value received by the control circuit is greater than the overload critical value m, the paper shredder is in the overload state, the control circuit triggers an overload protection instruction, and the paper shredder executes the overload protection instruction. For example, the shredding cutter 6 is controlled to make the set number of turns in a backward direction, then in a forward direction, and so forth at least once, for solving the problem of overload or paper jam.

The paper disposing mechanism and the automatic paper feeding channel 5 are located at two sides of the paper rolling device respectively; the automatic paper feeding channel 5 and the paper disposing area are located at two sides of the paper rolling device respectively; the position where the paper rolling device is located corresponds to the middle section of the paper disposing area or the paper sheet to be shredded 1.

The paper rolling device is located at least at the position above the lower end portion of the paper disposing area/paper sheets to be shredded 1; as long as the two adjacent paper sheets to be shredded 1 are superimposed partially at the higher side of the paper disposing area when the paper rolling device rubs the two adjacent paper sheets to be shredded 1, or the two adjacent paper sheets to be shredded 1 are superimposed partially after entering one side of the automatic paper feeding channel 5.

The paper rolling device starts to rub the paper sheets to be shredded from the position above the lower end portion of the paper sheets to be shredded or its middle portion to leave from the paper disposing area first, and to enter the automatic paper feeding channel in a forward direction again after the lower end portion of the paper sheet to be shredded gets over the paper rolling device.

The foregoing merely describes preferable embodiments of the present invention. For persons skilled in the art, according to the concepts of the present invention, there is a change in the embodiment and the application scope, and the contents of the present invention shall not be construed as limitations to the present invention.

What is claimed is:

1. An automatic paper feeding method for a paper shredder, comprising the following steps:
1) a step of disposing paper, in which the stacked paper sheets to be shredded (1) are disposed in a paper disposing area of a paper disposing mechanism to form a paper pile which is inserted from the outside of a paper rolling device, a lower end portion of the paper pile exceeds the paper rolling device by a distance of H, such that the paper sheets to be shredded (1) and an automatic paper feeding channel (5) are located at two sides of the paper rolling device respectively;
2) a step of pressing paper, in which a paper pressing mechanism presses the paper sheets to be shredded (1) against the paper rolling device;
3) a step of automatically rolling paper, in which the paper rolling device is controlled to rotate in a forward direction and to automatically roll paper sheets continuously, the upper part of the paper rolling device rotates towards the side where the automatic paper feeding channel (5) is located from the side where the paper sheets to be shredded (1) are located, the paper rolling device starts to rub the paper sheet to be shredded (1) from the position above the lower end portion of the paper sheet to be shredded (1), such that the lower end portion of the paper sheet to be shredded (1) gets over the paper rolling device after reaching the position where the paper rolling device is located and enters the automatic paper feeding channel (5);
4) a step of automatically feeding paper continuously, in which the paper rolling device is controlled to rotate in a forward direction persistently, and to continuously rub the paper sheet to be shredded (1) on the top of the paper pile, such that the paper sheets to be shredded (1) getting over and/or entering the automatic paper feeding channel (5) are superimposed partially;
5) a step of shredding paper, in which the paper sheets to be shredded (1) entering the automatic paper feeding channel (5) or several superimposed paper sheets to be shredded (1) are shredded by the shredding cutter (6) in a paper shredder core (9).

2. The automatic paper feeding method for a paper shredder according to claim 1, wherein the paper rolling device starts rubbing the paper sheets to be shredded (1) from the middle of the paper sheets to be shredded (1), such that the paper sheets to be shredded (1) entering the automatic paper feed channel (5) are arranged in an echeloned manner, and the two adjacent paper sheets to be shredded (1) are superimposed partially, the lower end portion of the paper pile exceeds the paper rolling device by a distance of H; by adjusting the distance H of the lower end portion of the paper pile exceeding the paper rolling device, the automatic feed speed and the superimposed length L of the two adjacent paper sheets to be shredded (1) entering the automatic paper feeding channel (5) are adjusted.

3. The automatic paper feeding method for a paper shredder according to claim 1, wherein a paper roller set or a paper roller (2) is used as the paper roiling, device, the lower end portion of the paper pile is inserted to the paper inserting chamber (4) located at the outside of the paper roller (2) or the lifting support board (3), and the bottom of the paper inserting chamber (4) or the lifting support board (3) is lower than the set height of the paper roller (2), by adjusting the position of the bottom of the paper inserting chamber (4) or the lifting support board (3) for supporting the paper pile with respect to the paper roller (2), the adjustment of the automatic feed speed is realized, comprising the adjustment of the superimposed length of the two adjacent paper sheets to be shredded (1) entering the automatic paper feeding channel (5), and the adjustment of the number of superimposed paper sheets to be shredded (1) entering the automatic paper channel (5).

4. The automatic paper feeding method for a paper shredder according to claim 1, wherein the automatic paper rolling step comprises the sub-processes:
a) a sub-process of rubbing paper sheets in a backward direction, in which the paper roller set or the paper roller (2) may be used as the paper rolling device, the paper roller (2) is controlled to rotate in a forward direction continuously; in, the case that the paper roller (2) rotates in a forward direction, only the paper sheet to be shredded (1) on the top of the paper pile is rubbed to move upwards or outwards, and the paper roller (2) starts rubbing the paper sheet to be shredded (1) from its middle, the lower end portion of the paper sheet to be shredded (1) contacting with the paper roller (2) is moved upwards or outwards to the position where the paper roller (2) is located;
b) a sub-process of getting over paper roller (2), in which after the rubbed lower end portion of the paper sheet to be shredded (1) is moved to the position where the paper roller (2) is located, as the paper roller (2) continues to rotate in a forward direction, the paper roller (2) roll-feeds or pushes the lower end portion of the paper sheet to be shredded (1), the lower end portion of the paper sheet to be shredded (1) is moved to the side where the automatic paper feeding channel (5) is located from the outside of the paper roller (2), the lower end portion of the paper sheet to be shredded (1) gets over the upper part of the paper roller (2) and enters the automatic paper feeding channel (5);
c) a sub-process of absorbing, rolling and shredding, in which the paper sheet to be shredded (1) entering the automatic paper feeding channel (5) is absorbed and rolled into the paper shredder core (9) by a paper absorbing and rolling mechanism or the shredding cutter (6) installed in the automatic paper feeding channel (5), and is shredded by the shredding cutter (6);
in the above-mentioned step, the paper sheets to be shredded (1) are rubbed to move and/or get over the paper roller (2) by a friction surface, grooves (8), concave stripes, convex stripes or convex teeth arranged on a surface of the paper roller (2).

5. The automatic paper feeding method for a paper shredder according to claim 1, wherein
the method has an anti-overload paper feed limiting step, in which at least one paper feeding set value and/or working strength set value is stored or set in a control circuit, by a detection device detecting the number/thickness of the paper sheets of the automatic paper feeding channel (5) and/or the working strength of the paper shredder, and conveying one corresponding detection value to the control circuit,
in the case that the detection value received by the control circuit is greater than the paper feeding set value or the working strength set value, the paper rolling is stopped by the control circuit controlling the paper rolling device, and the paper shredder stops the automatic paper feeding, but simultaneously, the shredding cutter (6) is controlled to keep shredding, until the detection value received by the control circuit is less than the paper feeding set value or the working strength set value, the paper rolling device is controlled by the control circuit again to resume the paper roiling, and the paper shredder resumes the, automatic paper feeding;
the number/thickness of the paper sheets to be shredded (1) entering the automatic paper feeding channel (5) is controlled within the set range, to avoid the overload of the paper shredder.

6. The automatic paper feeding method for a paper shredder according to claim 5, wherein in the anti-overload paper feed limiting step, one or a combination of the following modes is selected.
a) By a paper number/thickness detecting device detecting the number or thickness of the paper sheets to be shredded (1) entering the automatic paper feeding channel (5), and conveying one corresponding detection value to the control circuit, the control circuit compares the detection value with the paper feeding set value;
b) by a voltage/current detecting device detecting the working voltage or current of the shredding motor of the paper shredder, and conveying one corresponding detection value to the control circuit, the control circuit compares the detection value with the working strength set value;
in the case that the overload occurs in the paper shredder or the number of paper sheets of the automatic paper feeding channel (5) reaches the rated maximum, the paper shredder in this state is set to have an overload critical value m,
it is set that an increment of the detection value received by the control circuit is a single-sheet value n for each additional paper sheet to be shredded (1) in the automatic paper feeding channel (5), and the paper feeding set value or the working strength set value is set to be a;
in the case that the detection value received by the control circuit is greater than the paper feeding set value or the working strength set value, the detection value is still less than the overload critical value m, and the corresponding working state of the paper shredder at this point is as below: the paper shredder is not in the overload state, or does not reach the rated maximal working limit, or achieve the condition of triggering the overload protection;
overload critical value m−a>(0˜3)×single-sheet value
in the case that the detection value received by the control circuit is greater than the overload critical value m, the paper shredder is in the overload state, the control circuit triggers an overload protection instruction, and the paper shredder executes the overload protection instruction.

7. A paper shredder with an improved automatic paper feeding device, comprising a paper shredder head, on which an automatic paper feeding channel (5), a paper rolling device and a paper disposing mechanism are arranged, a shredding motor is mounted in the paper shredder head, a control circuit and a shredding cutter (6) are arranged in or below the automatic paper feeding channel (5), the shredding, motor is connected with the shredding cutter (6) in a transmission way, the paper disposing mechanism is provided with a paper disposing area for disposing paper sheets to be shredded (1), wherein automatic paper feeding channel (5) and the paper disposing area are located at two sides of the paper rolling device respectively;
the paper rolling device is located at the middle section of the paper disposing area/paper sheets to be shredded (1), or the paper rolling device is located at least at the position above the lower end portion of the paper disposing area/paper sheets to be shredded (1);
the paper rolling device starts to rub the paper sheets to be shredded (1) from the position above the lower end portion of the paper sheet to be shredded (1) or its middle portion to leave from the paper disposing area first, and to enter the automatic paper feeding channel (5) in a forward direction again after the lower end portion of the paper sheet to be shredded (1) gets over the paper rolling device.

8. The paper shredder with an improved automatic paper feeding device according to claim 7, wherein the paper shredder head is provided with a paper shredder core (9) and a transmission mechanism, the paper rolling device includes at least one spindle (10) and at least one paper roller (2), the spindle (0) is rotationally mounted at the paper shredder core (9), the transmission mechanism is connected with the spindle (10) in a transmission way, the spindle body is installed with at least one paper roller (2);
the paper disposing mechanism comprises at least one paper inserting chamber (4), the automatic paper feeding channel (5) and the paper inserting chamber (4) are located at two sides of the paper roller (2) respectively, and the paper inserting chamber (4) extends from a lower direction of the paper roller (2) at least to the position where the paper roller (2) is located, the paper roller (2) starts to rub the paper sheets to be shredded (1) from the middle of the paper sheets to be shredded (1) to leave from the paper inserting chamber (4) first, and to enter the automatic paper feeding channel (5) in a forward direction again after the lower end portion of the paper sheet to be shredded (1) gets over the paper roller (2).

9. The paper shredder with an improved automatic paper feeding device according to claim 7, wherein the paper shredder head is provided with a paper pressing mechanism which includes a paper pressing driving mechanism and a top paperboard (11), wherein the paper pressing driving mechanism is connected with the top paperboard (11) which extends into the paper inserting chamber (4) from its outside, the part of the top paperboard (11) extending into the paper inserting chamber (4) forms one paper pressing portion which is located at one side of the paper rolling device, and moves towards the paper rolling device.

10. The paper shredder with an improved automatic paper feeding device according to claim 7, wherein the paper shredder core (9) is rotationally provided with a driven shaft (12) which is arranged outside the paper inserting chamber (4), and is connected with the transmission mechanism in a transmission way; the shaft body of the driven shaft (12) is fixed with at least one friction transmission roller (13), a friction transmission hole is provided on the upper part of the top paperboard (11), and the friction transmission roller (13) is movably penetrated through the friction transmission hole; in the rotation of the driven shaft (12), the friction transmission roller (13) and the friction transmission hole are in transmission fit by the friction force between the roller surfaces; at least one window (14) is provided at the middle of an outer side wall of the paper inserting chamber (4); the lower middle part of the top paperboard (11) passes through the window (14) and extends into the paper inserting chamber (4), for abutting the middle part of the paper sheet to be shredded (1) inserted to the paper inserting chamber (4) against the paper roller (2).

11. The paper shredder with an improved automatic paper feeding device according to claim 8, wherein one to three paper rollers (2) is/are mounted at the middle and/or two sides of the spindle body respectively, and the surface of the paper roller (2) is provided with a rubbing friction surface, grooves 8, concave stripes, convex stripes or convex teeth;
an automatic paper entry slot (15) is arranged on the upper part of the paper shredder head, the paper inserting chamber (4) is arranged at the outside of the automatic paper entry slot (15), the paper roller (2) is located in the middle of the automatic paper entry slot (15), the automatic paper feeding channel (5) is arranged at an inside position of the automatic paper entry slot (15);
the paper disposing mechanism includes at least one paper supporting board (16) and at least one security coverplate (17); the lower end portion of the paper supporting board (16) is rotationally mounted at the upper part of the paper shredder head, and is connected with or dose to the upper portion of the back side wall of the paper inserting chamber (4): when the automatic paper feeding function is not used, the paper supporting board (16) is covered on the upper part of the automatic paper entry slot (15);
the inner side of the security coverplate (17) is pin jointed or damped at the Inner side of the automatic paper entry slot (15), the outer side of the security coverplate (17) is damped at the middle of the paper supporting board (16); during shredding, the security coverplate (17) covers on the automatic paper entry slot (15).

12. The paper shredder with an improved automatic paper feeding device according to claim 8, wherein the paper disposing area and/or the paper inserting chamber (4) is provided with a paper inserting depth adjusting mechanism which comprises a driving mechanism and a paper supporting mechanism which are connected with each other,
the paper supporting mechanism includes the bottom of the paper inserting chamber (4) or a lifting support board (3) arranged in the paper disposing area/paper inserting chamber (4); in the case that the feed speed tis adjusted, the driving mechanism drives the paper inserting chamber (4) or the listing support board (3) to rise or descend.

13. The paper shredder with an improved automatic paper feeding device according to claim 7, wherein the paper shredder is provided with a detection device for detecting the number/thickness of the paper sheets entering the automatic paper feeding channel (5) or a voltage/current of the paper shredder, and conveying a detection value to the control circuit; an input terminal of the control circuit is electrically connected with the detection device, an output terminal of the control circuit is electrically connected with a shredding motor and a paper rolling motor respectively;
the paper shredder has a normal shredding state, an anti-overload paper feed limiting shredding state and an overload protection state,
in the normal shredding state, the control circuit controls the paper rolling motor to rotate and the shredding motor to rotate, the paper rolling device rotates and roll-feeds the paper sheets to be shredded (1) into the automatic paper feeding channel (5), the shredding cutter (6) rotates to shred paper sheets;
in the anti-overload paper feed limiting shredding state, during the automatic paper feeding, in the case that the detection value received by the control circuit is greater than the paper feeding set value or the working strength set value, the control circuit controls the paper shredder to get into the anti-overload paper feed limiting shredding state, the control circuit controls the paper rolling motor to stop, the shredding motor keeps rotating, the paper rolling device stops paper rolling, and the shredding cutter (6) keeps shredding;
in the anti-overload paper feed limiting shredding state, in the case that the detection value received by the control circuit is less than the paper feeding set value or the working strength set value, the control circuit controls'the paper shredder to get into the normal shredding state, the control circuit controls the paper rolling motor to start rotating, the shredding motor keeps rotating, the paper rolling device starts rolling, and the shredding cutter (6) keeps shredding;
in the overload protection state, in the case that the detection value received by the control circuit is greater than an overload critical value m, the control circuit controls the paper shredder to get into the overload protection state.

14. The paper shredder with an improved automatic paper feeding device according to claim 13, wherein the control circuit is provided with a control unit which stores or sets the paper feeding set value or the working strength set value;
the paper shredder is provided with a paper number/thickness detecting device for detecting the number or thickness of the paper sheets entering the automatic paper feeding channel (5), and conveying one corresponding detection value to the control circuit, and/or the paper shredder is provided with a voltage/current detecting device for detecting the voltage or current of the shredding motor, and conveying one corresponding detection value to the control circuit;
the automatic paper feeding channel (5) and the paper disposing area are located at two sides of the paper rolling device respectively; the position where the paper rolling device is located corresponds to the middle section of the paper disposing area or the paper sheet to be shredded (1), or the paper rolling device is located at least at the position above the lower end portion of the paper disposing area/paper sheets to be shredded (1);
the paper rolling device starts to rub the paper sheets to be shredded (1) from the position above the lower end portion of the paper sheets to be shredded (1) or its middle portion to leave from the paper disposing area first, and to enter the automatic paper feeding channel (5) in a forward direction again after the lower end portion of the paper sheet to be shredded (1) gets over the paper rolling device.
